(19) United States
(12) Patent Application Publication
(10) Pub. No.: US 2005/0163169 A1
(43) Pub. Date: Jul. 28, 2005

(54) Solid state diamond Raman laser

(75) Inventors: Nabil M. Lawandy, Saunderstown, RI (US); Robert S. Afzal, Providence, RI (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(73) Assignee: Spectra Systems Corporation, Providence, RI (US)

(21) Appl. No.: 10/971,661

(22) Filed: Oct. 22, 2004

Related U.S. Application Data
(60) Provisional application No. 60/513,492, filed on Oct. 22, 2003.

(51) Int. Cl. H01S 3/30

(52) U.S. Cl. 372/3

(57) ABSTRACT

A solid state Raman laser includes a laser pump for producing a first radiation at a high power and at a first wavelength along an optical path, a solid Raman active medium in the optical path of the first radiation, the medium including single crystal diamond having a first surface and a second surface, where the first radiation at a high power produces stimulated Raman scattering in the medium and the medium generates a second radiation at a second wavelength, a first optical element in the optical path of the first radiation, wherein the first optical element allows the first wavelength to be transmitted and allows the second wavelength to be reflected, and a second optical element in the optical path of the first radiation, wherein the second optical element allows the first wavelength to be transmitted and allows the second wavelength to be reflected.

### CROSS-REFERENCE TO RELATED APPLICATIONS

This application claims the benefit under 35 U.S.C. § 119(e) to U.S. Provisional Application No. 60/513,492 filed Oct. 22, 2003, entitled “NONLINEAR OPTICS IN BULK DIAMONDS AND ITS APPLICATIONS,” the disclosure of which is incorporated by reference herein.

### FIELD OF THE INVENTION

This invention relates to Raman lasers and, in particular, to a diamond material suitable for use in solid state Raman lasers capable of high power operation.

### BACKGROUND OF THE INVENTION

Raman scattering is an inelastic light scattering process where the scattered radiation has a lower energy from the incident radiation. Stimulated Raman scattering (SRS) takes place with intense electromagnetic fields enhancing the process, where light at one wavelength, the pump wavelength, is converted to another wavelength, the Stokes wavelength, accompanied by an excitation within a Raman medium. The Raman medium used in Raman lasers includes solids, liquids and gases. A variety of crystalline materials have been used in solid state Raman lasers, however solid state Raman lasers typically become thermally limited due to increased Raman linewidth with increasing temperature. For example, solid state Raman lasers employing Ba(NO₃)₂ crystals become thermally limiting at operational powers of approximately 1 Watt, with potassium gadolium tungstate (KGW) crystals becoming limiting at powers of a few watts.

### SUMMARY OF THE INVENTION

In general, in one aspect, the invention features a solid state Raman laser including a laser pump for producing a first radiation at a high power and at a first wavelength along an optical path, a solid Raman active medium in the optical path of the first radiation, the medium comprising single crystal diamond having a first surface and a second surface, wherein the first radiation produces stimulated Raman scattering in the medium and the medium generates a second radiation at a second wavelength, a first optical element in the optical path of the first radiation, wherein the first optical element allows the first wavelength to be transmitted and allows the second wavelength to be reflected, and a second optical element in the optical path of the first radiation, wherein the second optical element allows the first wavelength to be transmitted and allows the second wavelength to be reflected.

In general, in another aspect, the invention features a method for making a solid state Raman laser capable of high power. A first radiation is produced at a high power and a first wavelength along an optical path. A solid Raman active medium is provided in the optical path of the first radiation, the medium including single crystal diamond having a first surface and a second surface. The first radiation is directed toward the medium wherein the first radiation produces stimulated Raman scattering in the medium and the medium generates a second radiation at a second wavelength.

An advantage of the present invention is that the solid state Raman laser is capable of operating in high power applications.

The details of one or more embodiments of the invention are set forth in the accompanying drawings and the description below. Other features, objects, and advantages of the invention will be apparent from the description, drawings and examples, and from the claims.

### BRIEF DESCRIPTION OF THE DRAWINGS

FIG. 1 is a schematic drawing of a solid state Raman laser according to an embodiment of the present invention;

FIG. 2 a schematic drawing of a solid state Raman laser according to an embodiment of the present invention;

FIG. 3 is a schematic drawing of a solid state Raman laser according to an embodiment of the present invention;

FIG. 4 is a graph showing the Raman spectra for a single crystal diamond sample used in making a solid state Raman laser according to an embodiment of the present invention; and

FIG. 5 is a schematic drawing of the Raman spectra collection system used to obtain the Raman spectra shown in FIG. 4.

### DETAILED DESCRIPTION

The present invention relates to a solid state Raman laser and method of making in which an efficient, high-powered Raman beam may be generated. When a laser source pumps a Raman material with an intensity sufficient to produce a stimulated Raman laser output beam, the generation of heat within the material typically becomes thermally limited at higher laser pump operational powers. For example, the conventional figure of merit for a given material, which is proportional to the Raman gain, is defined as:
FOM (calculated)=σ/Δν
where σ is the Raman cross-section and Δν is the linewidth. However, this calculated figure of merit does not factor in the dissipation of heat which exponentially broadens the linewidth and quenches stimulated Raman oscillation by reducing the Raman gain. The missing parameter which accounts for this phenomenon is the thermal diffusivity (K) of a given Raman material. Therefore, the operational figure of merit that a Raman material is capable of is defined as:
FOM (operational)=σK/Δν

A comparison of the conventional and actual figure of merit is shown below for some typical Raman generation materials.

TABLE 1

| | σ/Δυ | K (W/m-K) | σK/Δυ |
|---|---|---|---|
| Silica | 2.2 | 0.8 | 1.8 |
| KGW | 25 | 3 | 75 |
| Ba(NO₃)₂ | 63 | 1.16 | 73 |
| Diamond | 100 | 500 | 50,000 |

Therefore, a solid state Raman laser using a diamond material is capable of withstanding higher operational powers that may be employed.

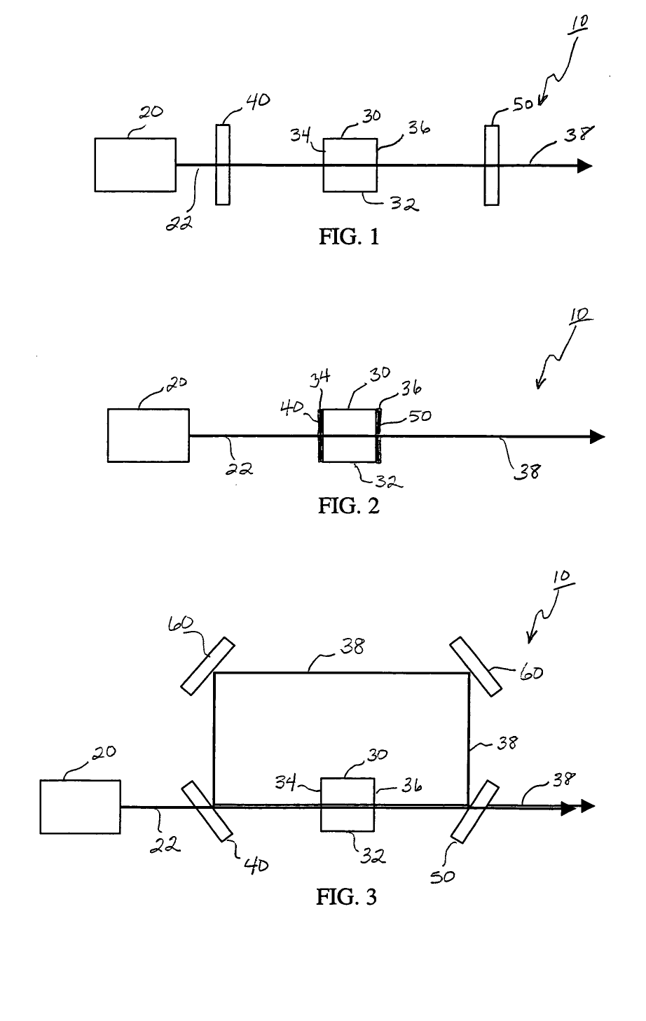

FIG. 1 shows a schematic drawing of a solid state Raman laser made according to an embodiment of the present invention. The solid state Raman laser 10 includes a laser pump 20 for producing a first radiation 22 at a high power and at a first wavelength along an optical path. Various types of laser pumps 20 having various wavelengths may be used depending on the desired application, such as, for example, a Nd:YAG or a diode-pumped solid state laser. Table 2 below shows an illustrative example of the various laser pump wavelengths that may be used with the corresponding Stokes wavelengths generated by an Nb:YAG and its harmonics that may be generated with a Raman laser of the present invention.

TABLE 2

Laser pump wavelength (λ)

| | 266 nm | 355 nm | 532 nm | 1064 nm |
|---|---|---|---|---|
| 1st stokes | 276 nm | 373 nm | 572 nm | 1240 nm |
| 2nd stokes | 286 nm | 392 nm | 620 nm | 1486 nm |
| 3rd stokes | 298 nm | 414 nm | 676 nm | 1853 nm |
| 4th stokes | 310 nm | 438 nm | 743 nm | 2460 nm |

As shown in Table 2, efficient, high energy, high repetition rate sources throughout the UV, visible and IR spectrum may be used in the present invention.

The Raman laser 10 of the present invention further includes a solid Raman active medium 30 in the optical path of the first radiation 22, the medium 30 comprising single crystal diamond 32 having a first surface 34 and a second surface 36, wherein the first radiation 22 produces stimulated Raman scattering in the medium 30 and the medium 30 generates a second radiation 38 at a second wavelength. The second wavelength may include a first order Stokes wavelength, a second order Stokes wavelength, a third order Stokes wavelength, a fourth order Stokes wavelength, and/or any higher order Stokes wavelengths and/or any combinations thereof.

The single crystal diamond 32 may be natural occurring or synthetically grown, such as with a chemical vapor deposition (CVD) process. Synthetically grown single crystal diamond suitable for use in the present invention is commercially available from Apollo Diamond Inc. of Massachusetts. In addition, the single crystal diamond 32 may be coated with one or more optical coatings, such as antireflection coatings and partial reflective coatings. The coating may be accomplished by a variety of known methods, including, for example, electron beam sputtering, ion assisted CVD, sol-gel or other coating methods well known to those skilled in the arts.

The Raman laser 10 of the present invention further includes a first optical element 40 and a second optical element 50 in the optical path of the first radiation 22, wherein the first optical element 40 and/or the second optical element 50 allows the first wavelength to be transmitted and allows the second wavelength to be reflected. As will be apparent to one skilled in the art, the percentage of transmitted and reflected wavelength may vary greatly for the optical elements used in the present invention depending on the desired application, pump power and/or laser efficiency. As used herein, the term highly reflective or highly transmissive means an optical element capable of 50% or greater reflection or transmission of the desired wavelength, preferably 70% or greater, and most preferably 90% or greater. In addition, as used herein, the term partially reflective means an optical element capable of greater than 0% to approximately 99% reflection of the desired wavelength, preferably greater than 0% to approximately 90%, and most preferably greater than 0% to approximately 80%.

As shown in FIG. 2, the first optical element 40 and/or the second optical element 50 may include one or more coatings applied to the surface of the single crystal diamond 32. Alternately, the first optical element 40 and/or the second optical element 50 may be the first surface 34 of the single crystal diamond 32 and/or the second surface 36 of the single crystal diamond 32.

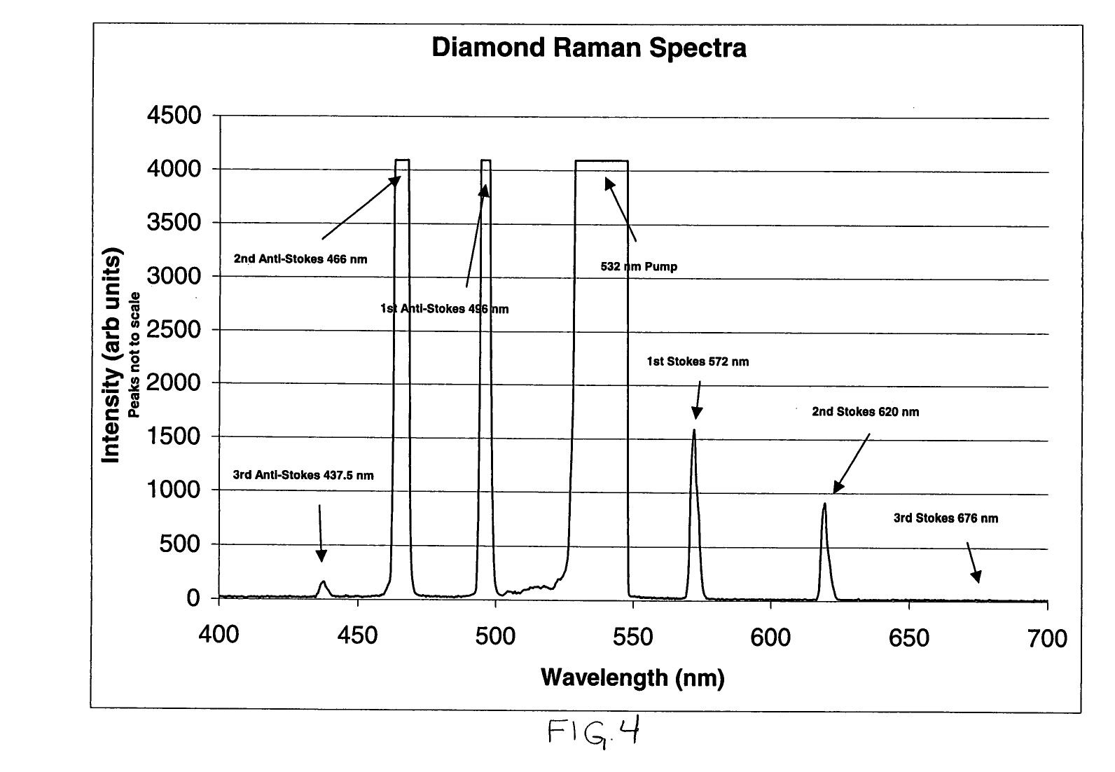

Additional optical elements and/or components may be used in the solid state Raman laser 10 of the present invention and method of making as will be apparent to those of ordinary skill in the art. For example, as shown in FIG. 3, a first optical element 40, a second optical element 50, and one or more third optical elements 60 may be positioned so as to create a ring cavity with respect to the Raman medium 30. For instance, the first optical element 40 may be highly transmissive to the first wavelength and highly reflective to the second wavelength, the second optical element 50 may be highly transmissive to the first wavelength and partially reflective to the second wavelength, and the one or more third optical elements 60 may be highly reflective to the second wavelength. Although FIG. 3 shows the ring cavity as a quadrangle, other geometries may also be employed.

A single pass or multiple passes of the laser pump beam 22 and/or the generated Stokes beam 38 in the solid state Raman medium 30 may be employed depending on the application and/or desired efficiency of the Raman laser. In addition, the components of the Raman laser 10 may be arranged differently and/or one or more of the components may be combined.

A method for making a solid state Raman laser involves using a single crystal diamond in the system as described above. A first radiation 22 is produced at a high power and a first wavelength along an optical path. A solid Raman active medium 30 is provided in the optical path of the first radiation 22, the medium 30 including single crystal diamond 32 having a first surface 34 and a second surface 36. The first radiation 22 is directed toward the medium 30 wherein the first radiation 22 produces stimulated Raman scattering in the medium 30 and the medium 30 generates a second radiation 38 at a second wavelength.

The solid state Raman laser 10 of the present invention may be used for a variety of applications. For example, the Raman laser of the present invention may be used to machine a workpiece. The laser machining includes providing a solid state Raman laser of the present invention and directing the second radiation generated by the Raman laser toward the workpiece to machine the workpiece. The Raman laser of the present invention may also be used to administer a therapeutic wavelength for photomedicine applications. The application includes providing a solid state Raman laser of the present invention and delivering the second radiation generated by the Raman laser to a predetermined area. The second radiation may be delivered by a variety of means, such as an optical fiber, a waveguide, and/or an articulating arm.

The Raman laser of the present invention may also be used to remotely sense an object. The remote sensing includes providing a solid state Raman laser of the present invention, directing the second radiation generated by the Raman laser toward the object, detecting light scattered from the object; and processing the detected light. The Raman laser of the present invention may also be used to find the range of an object. The laser range finding includes providing a solid state Raman laser of the present invention, directing the second radiation generated by the Raman laser toward the object, wherein the second radiation is in the eye safe region of the optical spectrum, detecting light scattered from the object, and processing the detected light. Wavelengths of approximately 1300 nm or greater are considered to be in the eye safe region of the optical spectrum.

To further illustrate the present invention, the following Example is provided, but the present invention is not to be construed as being limited thereto.

### EXAMPLE

A Raman laser was produced with a single crystal diamond Raman material. An Nd:YAG laser was used, frequency doubled to 532 nm operating at 40 Hz, 1.62 ml, 3 nsec per pulse with approximately a 0.7 mm spot size. The single crystal diamond sample measured approximately 5 mm×5 mm and approximately 0.5 mm thick. The faces of the sample were polished with the edges remaining unpolished.

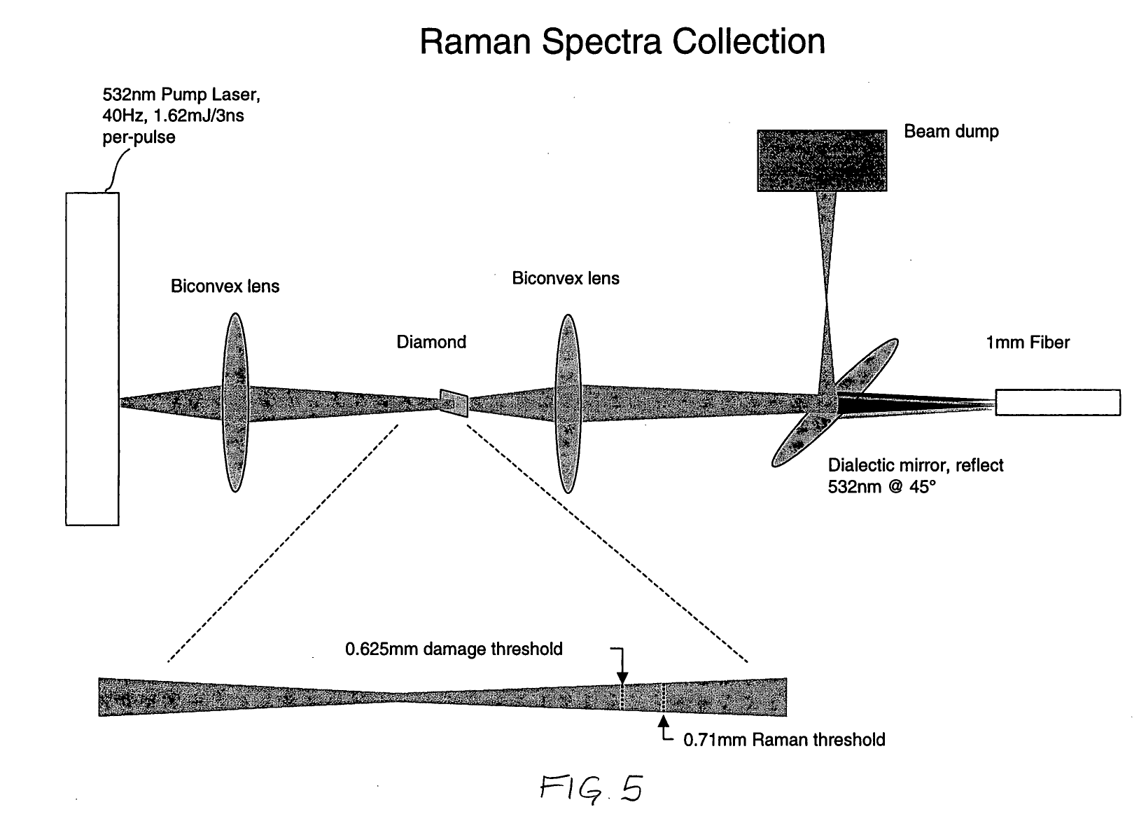

A Raman spectra of the single crystal diamond sample was collected and is shown in FIG. 4. FIG. 5 shows the schematic arrangement of the Raman spectra collection system used to obtain the Raman spectra shown in FIG. 4.

The diamond sample was positioned in the optical path of the Nd:YAG laser without any additional optical elements employed and a Raman beam was generated with a single pass of the Nd:YAG laser.

For a Raman laser the threshold condition is given by:
Threshold=1=R₁R₂e^{2(g}^{ₒ}^{lI-L)}

Where R₁ is the reflection coefficient of mirror 1, R₂ is the reflection coefficient of mirror 2, L is the single pass non-useful losses of the cavity, I is the crystal length, I is the intensity of the pump beam and gₒ is the material Raman gain coefficient.

For the present example, R₁=R₂=0.15, which is the reflectivity of uncoated diamond, I=110 MW/cm², 1=0.05 cm and L=0.05 cm. A Raman gain coefficient of 0.035 cm/MW was calculated for the present configuration. As will be apparent to one skilled in the art, the threshold for the Raman laser of the present invention may be varied depending on the system configurations. For example, the threshold for the Raman laser may be reduced to 10 MW/cm² if the system configuration utilizes mirrors with R₁=1.0 and R₂=0.5, and a 0.5 cm crystal. In addition, other configurations may also be utilized depending on the desired application.

As evident from the Example as described herein, a Raman laser for high power applications may be realized by using a single crystal diamond material in a Raman laser system of the present invention. However, since certain changes and modifications in the article and method which embody the invention can be made, it is intended that all matter contained in the Example be considered illustrative and not definitive.

It is to be understood that the herein described embodiments are simply illustrative of the principles of the invention. Various and other modifications, alterations, and variations may be made by those skilled in the art which will embody the principles of the invention and fall within the spirit and scope of the appended claims.

1. A solid state Raman laser comprising:
a laser pump for producing a first radiation at a high power and at a first wavelength along an optical path;
a solid Raman active medium in the optical path of the first radiation, the medium comprising single crystal diamond having a first surface and a second surface, wherein the first radiation at a high power produces stimulated Raman scattering in the medium and the medium generates a second radiation at a second wavelength;
a first optical element in the optical path of the first radiation, wherein the first optical element allows the first wavelength to be transmitted and allows the second wavelength to be reflected; and
a second optical element in the optical path of the first radiation, wherein the second optical element allows the first wavelength to be transmitted and allows the second wavelength to be reflected.

2. The laser of claim 1, wherein the first optical element is the first surface of the single crystal diamond and the second optical element is the second surface of the single crystal diamond.

3. The laser of claim 1, wherein the first optical element is a coating on the first surface of the single crystal diamond.

4. The laser of claim 1, wherein the second optical element is a coating on the second surface of the single crystal diamond.

5. The laser of claim 1, wherein the first wavelength is in the ultraviolet, visible or infrared region.

6. The laser of claim 1, wherein the solid Raman active medium further comprises at least one optically active coating.

7. The laser of claim 1, wherein the single crystal diamond is produced by chemical vapor deposition.

8. The laser of claim 1, where the single crystal diamond is synthetically grown.

9. The laser of claim 1, wherein the second wavelength is a first order Stokes wavelength, a second order Stokes wavelength, a third order Stokes wavelength, a fourth order Stokes wavelength, or any combination thereof.

10. The laser of claim 1, wherein the first optical element is highly transmissive to the first wavelength and is highly reflective to the second wavelength.

11. The laser of claim 1, wherein the second optical element is highly transmissive to the first wavelength and is partially reflective to the second wavelength.

12. The laser of claim 1 further comprising one or more third optical elements, wherein the first optical element is highly transmissive to the first wavelength and highly reflective to the second wavelength, wherein the second optical element is highly transmissive to the first wavelength and partially reflective to the second wavelength, and wherein the one or more third optical elements are highly reflective to the second wavelength, the first optical element, second optical element and one or more third optical elements create a ring cavity surrounding the single crystal diamond.

13. The laser of claim 1, wherein the second radiation is passed through the medium.

14. The laser of claim 1, wherein the laser pump is a diode-pumped solid state laser.

15. A method for making a solid state Raman laser comprising:
producing a first radiation at a high power and at a first wavelength along an optical path;
providing a solid Raman active medium in the optical path of the first radiation, the medium comprising single crystal diamond having a first surface and a second surface; and
directing the first radiation toward the medium wherein the first radiation at a high power produces stimulated Raman scattering in the medium and the medium generates a second radiation at a second wavelength.

16. The method of claim 15 further comprising
providing a first optical element in the optical path of the first radiation, wherein the first optical element is highly transmissive to the first wavelength and highly reflective to the second wavelength; and
providing the second optical element in the optical path of the first radiation, wherein the second optical element is highly transmissive to the first wavelength and partially reflective to the second wavelength.

17. The method of claim 16 further comprising
providing one or more third optical elements, wherein the one or more third optical elements are highly reflective to the second wavelength.

18. The method of claim 15 further comprising
coating the medium with at least one optically active coating.

19. The method of claim 18, wherein the first optical element is the at least one optically active coating on the medium.

20. The method of claim 18, wherein the second optical element is the at least one optically active coating on the medium.

21. The method of claim 15 further comprising
directing the second radiation toward the medium.

22. The method of claim 15, wherein the second wavelength is a first order Stokes wavelength, a second order Stokes wavelength, a third order Stokes wavelength, a fourth order Stokes wavelength, or any combination thereof.

23. A method of laser machining comprising:
providing a solid state Raman laser according to claim 1; and
directing the second radiation generated by the Raman laser toward a workpiece thereby machining the workpiece with the Raman laser.

24. A method of photomedicine comprising:
providing a solid state Raman laser according to claim 1; and
delivering the second radiation generated by the Raman laser to a predetermined area thereby administering a therapeutic wavelength.

25. The method of claim 24, wherein the second radiation is delivered by an optical fiber, a waveguide, an articulating arm, or any combination thereof.

26. A method of remote sensing comprising:
providing a solid state Raman laser according to claim 1;
directing the second radiation generated by the Raman laser toward an object;
detecting light scattered from the object; and
processing the detected light thereby sensing the remote object.

27. A method of laser range finding comprising:
providing a solid state Raman laser according to claim 1;
directing the second radiation generated by the Raman laser toward an object, wherein the second radiation is in the eye safe region of the optical spectrum;
detecting light scattered from the object; and
processing the detected light thereby finding the range of the object by the Raman laser.
